(19) United States
(12) Patent Application Publication
(10) Pub. No.: US 2024/0317057 A1
(43) Pub. Date: Sep. 26, 2024

(54) USER INTERFACE WITH A DIAL CONTROLLER INCLUDING A ROTATABLE DIAL THAT CAN BE MANIPULATED ALONG OR ABOUT THREE AXES

(71) Applicant: GHSP, INC., Holland, MI (US)

(72) Inventors: Jeffrey Lee Bays, Grand Haven, MI (US); Nicholas Jon Spitler, Grand Haven, MI (US); Richard William Harris, Wyoming, MI (US)

(21) Appl. No.: 18/567,560

(22) PCT Filed: Jun. 8, 2022
(86) PCT No.: PCT/IB2022/055358

§ 371 Date: Dec. 6, 2023

Related U.S. Application Data
(60) Provisional application No. 63/208,176, filed on Jun. 8, 2021.

(51) Int. Cl. B60K 35/10; B60K 35/22; B60K 35/28; G05G 1/01; G05G 1/015; G05G 5/03; G05G 5/05

(52) U.S. Cl. CPC B60K 35/10; B60K 35/22; B60K 35/28; G05G 1/01; G05G 1/015; G05G 5/03; G05G 5/05; B60K 2360/126; B60K 2360/128; B60K 2360/137; B60K 2360/1523; B60K 2360/16; B60K 2360/48; B60K 2360/695; B60K 2360/774; G05G 2505/00

(57) ABSTRACT

A dial controller for a vehicle comprises: (a) a rotatable dial that is (i) rotatable about an axis of rotation. (ii) linearly movable along a line parallel to the axis of rotation, and (iii) movable along a plane parallel to the axis of rotation: (b) a first sensor operably connected to the rotatable dial, the first sensor producing an output that is a function of rotation of the rotatable dial about the axis of rotation: (c) a second sensor operably connected to the rotatable dial, the second sensor producing an output that is a function of movement of the rotatable dial along the line parallel to the axis of rotation; and (d) a third sensor operably connected to rotatable dial, the third sensor producing an output that is a function of movement of the rotatable dial along the plane parallel to the axis of rotation.

### FIELD OF THE DISCLOSURE

This disclosure pertains to a dial controller for a vehicle, such as that used in conjunction with a user interface.

### BACKGROUND

Horse-drawn carriages sometimes included a dashboard between a passenger of the carriage and a horse pulling the carriage, to protect the passenger from debris that the horse kicked backwards. With the advent of non-horse propulsion, such as combustion engines and electric motors, the dashboard remained a feature and became a platform for human-machine interfaces that allow the passenger to control various functions of the vehicle. The vehicle evolved to include numerous dials, levers, buttons, and the like scattered about the dashboard, a center console of the vehicle, and even to a steering wheel. Some vehicles have consolidated some of the human-machine interfaces into a single human-machine interface with a touch screen, which allows the passenger to control various functions of the vehicle via touch. However, even then, there remains a problem in that the passenger can be dissatisfied (i) with the number of disparate human-machine interfaces still present within the vehicle and (ii) with the navigability of the touch screen human-machine interface.

### SUMMARY

The present disclosure addresses that problem with a user interface that utilizes a display and a dial controller with a rotatable dial that can be manipulated along or about three axes to interact with the display to select vehicle functions to control. Movement of the rotatable dial along one axis can change the menu of functions displayed for control. Movement of the rotatable dial about another axis can select a particular function to control, and can control an aspect of that function. A selector button is included to confirm passenger selection. Movement of the rotatable dial along another axis can change the menu of functions or control an aspect of a selected function, or even control movement of the vehicle. For example, passenger manipulation of the rotatable dial forward can cause the vehicle to move forward, and passenger rotation of the rotatable dial can cause the vehicle to turn while moving forward. The ability of the passenger to move the rotatable dial in multiple axes (e.g., forward and reverse, up and down, and rotate) obviates a touch screen user interface, and eases passenger navigation through vehicle controls.

In a first aspect of the present disclosure, a dial controller for a vehicle comprises: (a) a rotatable dial that is (i) rotatable about an axis of rotation, (ii) linearly movable along a line parallel to the axis of rotation, (iii) movable along a plane parallel to the axis of rotation; (b) a first sensor operably connected to the rotatable dial, the first sensor producing an output that is a function of rotation of the rotatable dial about the axis of rotation; (c) a second sensor operably connected to the rotatable dial, the second sensor producing an output that is a function of movement of the rotatable dial along the line parallel to the axis of rotation; and (d) a third sensor operably connected to the rotatable dial, the third sensor producing an output that is a function of movement of the rotatable dial along the plane parallel to the axis of rotation.

According to a second aspect of the present disclosure, the first aspect further comprises: a selector button proximate the rotatable dial, the selector button being depressible along the axis of rotation of the rotatable dial; and a fourth sensor operably connected to the selector button, the fourth sensor produces an output that is a function of depression of the selector button.

According to a third aspect of the present disclosure, the second aspect, wherein (i) the rotatable dial encircles the selector button about the axis of rotation of the rotatable dial; (ii) the selector button intersects the axis of rotation of the rotatable dial; (iii) as the rotatable dial rotates about the axis of rotation, the selector button does not rotate about the axis of rotation; and (iv) the selector button is biased along the axis of rotation away from being depressed.

According to a fourth aspect of the present disclosure, any one of the second through third aspects, wherein rotation of the rotatable dial about the axis of rotation chooses a function from a menu of functions to use or control; and depression of the selector button confirms the choice and allows use or control of the chosen function.

According to a fifth aspect of the present disclosure, any one of the first through fourth aspects, wherein the first sensor is a rotary encoder or a Hall sensor.

According to a sixth aspect of the present disclosure, the fifth aspect further comprises a stepper motor comprising a shaft and a gear attached to the shaft; wherein (i) the rotatable dial is attached to a first end of a cylinder through which the axis of rotation extends; (ii) the cylinder further comprises a second end and a gear at the second end that is operably connected to the gear of the stepper motor; (iii) rotation of the rotatable dial about the axis of rotation causes the cylinder to rotate and thus the gear at the second end of the cylinder to rotate; (iv) rotation of the gear of the cylinder causes the gear of the stepper motor to rotate, and rotation of the gear of the stepper motor causes the shaft of the stepper motor to rotate; (v) the first sensor is positioned relative to the stepper motor to generate an output that is a function of a fraction of a revolution of the shaft; (vi) the stepper motor resists rotation of the shaft and thus rotation of the rotatable dial at each fraction of the revolution of the shaft; and (vii) a torque applied to the rotatable dial is required to overcome the resistance.

According to a seventh aspect of the present disclosure, the sixth aspect, wherein (i) rotation of the rotatable dial about the axis of rotation chooses a function from a menu of functions to use or control; and (ii) the resistance that the stepper motor applies to the rotatable dial must be overcome to rotate the rotatable dial the fraction of a revolution and scroll to the next function in the menu of functions.

According to an eighth aspect of the present disclosure, the sixth aspect, wherein (i) rotation of the rotatable dial about the axis of rotation controls a controllable aspect of the chosen function; and (ii) the resistance that the stepper motor applies to the rotatable dial must be overcome to rotate the rotatable dial the fraction of a revolution and cause a change in the controllable aspect.

According to a ninth aspect of the present disclosure, any one of the sixth through eighth aspects, wherein the shaft of the stepper motor is substantially parallel to the axis of rotation of the rotatable dial.

According to a tenth aspect of the present disclosure, any one of the first through ninth aspects further comprises: a second cylinder through which the axis of rotation of the rotatable dial extends, the second cylinder comprising a first end around which the rotatable dial rotates and a second end from which an extension extends, the extension terminating in a sensor contacting surface that contacts the second sensor; wherein, the second sensor is a linear displacement sensor comprising (i) a fixed part statically attached to a fixed base of the dial controller and (ii) a movable part that contacts the sensor contacting surface of the second cylinder, the movable part being movable relative to the fixed part, and movement of the movable part of the second sensor relative to the fixed part of the second sensor alters the output of the second sensor; wherein, the movable part is biased toward the sensor contacting surface of the second cylinder; and wherein, movement of the rotatable dial along the line parallel to the axis of rotation of the rotatable dial causes the second cylinder to move and thus the movable part of the second sensor.

According to an eleventh aspect of the present disclosure, the tenth aspect further comprises: (i) a second base coupled to the fixed base, the fixed base substantially denying movement of the second base along the line parallel to the axis of rotation; and (ii) a retainer projecting from the second base toward the second cylinder, the retainer being movable away from the second cylinder but biased toward the second cylinder; wherein, the second cylinder further comprises at least two indents disposed between the first end and the second end of the second cylinder, the at least two indents being spaced differently between the first end and the second end; wherein, the retainer is configured to project into one of the at least two indents of the second cylinder at a time; and wherein, a force applied to the rotatable dial along the line parallel to the axis of rotation overcomes bias of the retainer into one of the at least two indents of the second cylinder, the second cylinder moves along the line parallel to the axis of rotation, and the retainer is biased to project into another of the at least two indents of the second cylinder.

According to a twelfth aspect of the present disclosure, any one of the first through eleventh aspects, wherein movement of the rotatable dial along the line parallel to the axis of rotation of the rotatable dial changes from one menu of functions to use or control to another menu of functions to use or control.

According to a thirteenth aspect of the present disclosure, the first aspect further comprises: (a) a fixed base to which the third sensor attached; and (b) a second base to which the rotatable dial is attached, the second base (i) comprising a sensor contacting surface and (ii) movable along the plane parallel to the axis of rotation; wherein, the third sensor is a linear displacement sensor comprising (i) a fixed part statically attached to the fixed base and (ii) a movable part that contacts the sensor contacting surface of the second base, the movable part being movable relative to the fixed part, and the output that the third sensor produces is a function of position of the movable part relative to the fixed part; wherein, the movable part of the third sensor is biased toward the sensor contacting surface of the second base; and wherein, movement of the second base along the plane parallel to the axis of rotation of the rotatable dial causes the movable part of the third sensor to move.

According to a fourteenth aspect of the present disclosure, the thirteenth aspect, wherein (i) the fixed base comprises a platform and a pair of parallel rails upon the platform; (ii) one rail of the pair of parallel rails is disposed to one side of the plane and the other rail is disposed to the other side of the plane; and (iii) the second base moves relative to the fixed base upon the pair of parallel rails.

According to a fifteenth aspect of the present disclosure, any one of the thirteenth through fourteenth aspects, wherein (i) the fixed base further comprises a first wall and a second wall extending from the platform, with the second base and the pair of parallel rails disposed between the first wall and the second wall; (ii) a first spring connected to both the first wall of the fixed base and the second base; (iii) a second spring connected to both the second wall of the fixed base and the second base; (iv) the first spring and the second spring cooperate to bias the second base and thus the rotatable dial to a neutral position along the plane parallel to the axis of rotation; and (v) the rotatable dial is moved along the plane when resistance imparted by either the first spring or the second spring is overcome.

According to a sixteenth aspect of the present disclosure, any one of the first through fifteenth aspects, wherein (i) the dial controller is disposed within a vehicle; and (ii) movement of the rotatable dial along the plane parallel to the axis of rotation causes the vehicle to move.

According to a seventeenth aspect of the present disclosure, the sixteenth aspect, wherein rotation of the rotatable dial about the axis of rotation causes the vehicle to turn.

According to an eighteenth aspect, any one of the thirteenth through fifteenth aspects further comprises: a second cylinder through which the axis of rotation of the rotatable dial extends, the second cylinder comprising a first end around which the rotatable dial rotates and a second end from which an extension extends, the extension terminating in a sensor contacting surface that contacts the second sensor; wherein, the second sensor is disposed on a different side of the platform as the rotatable dial; wherein, the platform of the fixed base comprises a slot; and wherein, the extension from the second cylinder extends through the slot of the platform.

According to a nineteenth aspect, the eighteenth aspect, wherein (i) the second cylinder further comprises a second extension; (ii) the platform of the fixed base further comprises an aperture sized to receive the second extension; (iii) when the rotatable dial is placed along the line parallel to the axis of rotation closest to the platform of the fixed base, the second extension of the second cylinder is disposed within the aperture of the platform of the fixed base and the rotatable dial cannot move along the plane parallel to the axis of rotation; and (iv) when the rotatable dial is placed along the line parallel to the axis of rotation furthest from the platform of the fixed base, the second extension of the second cylinder is not disposed within the aperture of the platform of the fixed base and the rotatable dial can move along the plane parallel to the axis of rotation.

According to a twentieth aspect, a user interface for a vehicle comprises: (1) a panel; (2) a display; (3) a dial controller in communication with the display, the dial controller comprising: (a) a rotatable dial disposed above the panel, the rotatable dial being (i) rotatable about an axis of rotation, (ii) linearly movable along a line parallel to the axis of rotation, (iii) movable along a plane parallel to the axis of rotation; (b) a first sensor operably connected to the rotatable dial and disposed below the panel, the first sensor producing an output that is a function of rotation of the rotatable dial about the axis of rotation; (c) a second sensor operably connected to the rotatable dial and disposed below the panel, the second sensor producing an output that is a function of movement of the rotatable dial along the line parallel to the axis of rotation; and (d) a third sensor operably connected to the rotatable dial and disposed below the panel, the third sensor producing an output that is a function of movement of the rotatable dial along the plane parallel to the axis of rotation.

According to a twenty-first aspect of the present disclosure, the twentieth aspect, wherein the dial controller further comprises: (i) a selector button proximate the rotatable dial, the selector button being depressible above the panel along the axis of rotation of the rotatable dial; and (ii) a fourth sensor disposed above the panel and operably connected to the selector button, the fourth sensor produces an output that is a function of depression of the selector button.

According to a twenty-second aspect of the present disclosure, the twenty-first aspect, wherein (i) the display displays a menu of functions to use or control; (ii) rotation of the rotatable dial about the axis of rotation chooses a function from a menu of functions to use or control; and (iii) depression of the selector button confirms the choice and allows use or control of the chosen function.

According to a twenty-third aspect of the present disclosure, the twenty-second aspect, wherein rotation of the rotatable dial about the axis of rotation controls a controllable aspect of the chosen function.

According to a twenty-fourth aspect of the present disclosure, any one of the twentieth through twenty-third aspects, wherein (a) the panel comprises a slot disposed below the rotatable dial; (b) the dial controller further comprises a second cylinder through which the axis of rotation of the rotatable dial extends; (c) the second cylinder comprises a first end disposed above the panel around which the rotatable dial rotates and a second end disposed below the panel from which an extension extends, the extension terminating in a sensor contacting surface that contacts the second sensor; (d) the second sensor is a linear displacement sensor comprising (i) a fixed part statically attached to a fixed base of the dial controller and (ii) a movable part that contacts the sensor contacting surface of the second cylinder, the movable part being movable relative to the fixed part, and movement of the movable part of the second sensor relative to the fixed part of the second sensor alters the output of the second sensor; (e) the movable part is biased toward the sensor contacting surface of the second cylinder; and (f) movement of the rotatable dial along the line parallel to the axis of rotation of the rotatable dial causes the second cylinder to move and thus the movable part of the second sensor.

According to a twenty-fifth aspect of the present disclosure, the twenty-fourth aspect, wherein movement of the rotatable dial along the plane parallel to the axis of rotation causes the second cylinder of the dial controller to move within the slot through the panel.

According to a twenty-sixth aspect of the present disclosure, any one of the twentieth through twenty-fifth aspects, wherein movement of the rotatable dial along the line parallel to the axis of rotation of the rotatable dial causes the display to change from displaying one menu of functions to use or control to displaying another menu of functions to use or control.

According to a twenty-seventh aspect of the present disclosure, any one of the twentieth through twenty-sixth aspects, wherein (i) the user interface is disposed within a vehicle; and (ii) movement of the rotatable dial along the line parallel to the axis of rotation of the rotatable dial causes the dial controller to control movement of the vehicle.

According to a twenty-eighth aspect of the present disclosure, any one of the twentieth through twenty-seventh aspects, wherein (a) a fixed base disposed below the panel to which the third sensor is attached; (b) a second base disposed below the panel to which the rotatable dial is operably coupled, the second base (i) comprising a sensor contacting surface and (ii) movable along the plane parallel to the axis of rotation; (c) the third sensor is a linear displacement sensor comprising (i) a fixed part statically attached to the fixed base and (ii) a movable part that contacts the sensor contacting surface of the second base, the movable part being movable relative to the fixed part, and the output the third sensor produces is a function of position of the movable part relative to the fixed part; (d) the movable part of the third sensor is biased toward the sensor contacting surface of the second base; and (e) movement of the second base along the plane parallel to the axis of rotation of the rotatable dial causes the movable part of the third sensor to move.

According to a twenty-ninth aspect of the present disclosure, any one of the twentieth through twenty-eighth aspects, wherein (i) the user interface is disposed within a vehicle; and (ii) movement of the rotatable dial along the plane parallel to the axis of rotation causes the vehicle to move forward or reverse.

According to a thirtieth aspect of the present disclosure, the twenty-ninth aspect, wherein rotation of the rotatable dial about the axis of rotation causes the vehicle to turn.

According to a thirty-first aspect of the present disclosure, the twenty-first aspect, wherein the rotatable dial, the selector button, and the fourth sensor are all disposed above the panel.

According to a thirty-second aspect of the present disclosure, any one of the twentieth through thirty-first aspects, wherein the display is disposed below but visible through the panel.

### BRIEF DESCRIPTION OF THE DRAWINGS

In the figures:

FIG. 1 is a perspective view of a vehicle illustrating a user interface in phantom disposed in an interior of the vehicle;

FIG. 2 is an overhead perspective view from the interior of the vehicle, illustrating the user interface of FIG. 1 including a dial controller with a rotatable dial in communication with a display disposed below a panel that is sufficiently transparent for a passenger to view the display;

FIG. 3 is a perspective view of the user interface of FIG. 1, illustrating a fixed base of the dial controller disposed below the panel and the rotatable dial disposed above the panel, and the rotatable dial including a selector button;

FIG. 4 is an elevation view of the user interface of FIG. 1, illustrating the rotatable dial having an axis of rotation about which the passenger can rotate the rotatable dial to utilize the user interface, and illustrating that the passenger can move the rotatable dial along a line parallel with the axis of rotation (e.g., up and down) and can move the rotatable dial along a plane through which the axis of rotation extends (e.g., forward and reverse) to further utilize the user interface;

FIG. 5 is a perspective exploded view of the user interface of FIG. 1, illustrating that the display is disposed below, but visible through, the panel;

FIG. 6 is an elevation view of the dial controller, illustrating a first sensor that produces an output that is a function of rotation of the rotatable dial about the axis of rotation and a second sensor that produces an output that is a function of movement and position of the rotatable dial along the line parallel to the axis of rotation (e.g., up and down);

FIG. 7 is another elevation view of the dial controller, illustrating the rotatable dial connected to a cylinder with a gear that drives a gear of a stepper motor, of which the first sensor senses rotation;

FIG. 8 is another elevation view of the dial controller, illustrating the first sensor disposed proximate the stepper motor;

FIG. 9 is another elevation view of the dial controller, illustrating the second sensor including a fixed part and a movable part that is biased to contact a sensor contacting surface operably coupled to the rotatable dial, so that when the passenger moves the rotatable dial along the line parallel to the axis of rotation (e.g., up or down), the sensor contacting surface and the movable part of the second sensor move the same, producing output indicative of the movement and position of the rotatable dial;

FIG. 10 is an overhead view of the dial controller, illustrating a fixed base and a second base coupled to the fixed base, the second base being configured to move as the passenger moves the rotatable dial along the plane through which the axis of rotation extends (e.g., forward or reverse), and including a sensor contacting surface that manipulates a movable part of a third sensor attached to the fixed base, so the third sensor can produce an output indicative of the movement and position of the rotatable dial;

FIG. 11 is an underneath view of the dial controller, illustrating a bracket extending from a platform of the fixed base to hold the second sensor;

FIG. 12 is a perspective view of a cross-section of the dial controller taken through line XII-XII of FIG. 6, illustrating the first sensor disposed below the stepper motor;

FIG. 13 is a perspective view of a cross-section of the dial controller taken through line XIII-XIII of FIG. 9, illustrating the rotatable dial operably connected to a second cylinder extending through the cylinder, the second cylinder including at least two indents that cooperate with a retainer attached to the second base to maintain positioning of the rotatable dial along the line parallel to the axis of rotation (e.g., up and down);

FIG. 14 is a perspective view of a cross-section of the dial controller taken through line XIV-XIV of FIG. 7, illustrating an extension extending from the second cylinder terminating with the sensor contacting surface that interacts with the second sensor, the extension extending through a slot through the platform of the fixed base, and a second extension extending from the second cylinder extending through an aperture through the platform of the fixed base to lock the rotatable dial in position along the plane extending through the axis of rotation (e.g., forward and reverse) unless the passenger has moved the rotatable dial along the line parallel with the axis of rotation away from the fixed base (e.g., up) so that the second extension withdraws from the aperture;

FIG. 15 is a perspective view of the dial controller, illustrating the slot through the platform of the fixed base elongated parallel to the plane through which the axis of rotation extends (e.g., forward and reverse) to allow the extension interacting with the second sensor to move through the slot as the passenger manipulates the rotatable dial along the plane (e.g., forward and reverse);

FIG. 16 is a perspective view of a cross-section of the dial controller taken through line XVI-XVI of FIG. 6, illustrating a pair of braces attached to the second base extending at least partially around the second cylinder to maintain the second cylinder in place, and the pair of braces having keys that extend into receivers of the second cylinder to prevent substantial rotation of the second cylinder when the passenger rotates the rotatable dial about the axis of rotation;

FIG. 17 is a perspective view of the user interface of FIG. 1 with the dial controller, illustrating the display displaying a menu of usable or controllable functions from which the passenger can make a selection via the rotatable dial and the selector button;

FIG. 18 is a perspective view of a moment in time after FIG. 17, where the passenger has utilized the rotatable dial to select a different function to control from the menu and to control a controllable aspect of that function (e.g., increase volume of audio); and

FIG. 19 is a schematic diagram of a controller of the vehicle of FIG. 1, illustrating the controller in communication with the display of user interface, as well as the first sensor, the second sensor, the third sensor of the dial controller, among other things.

### DETAILED DESCRIPTION

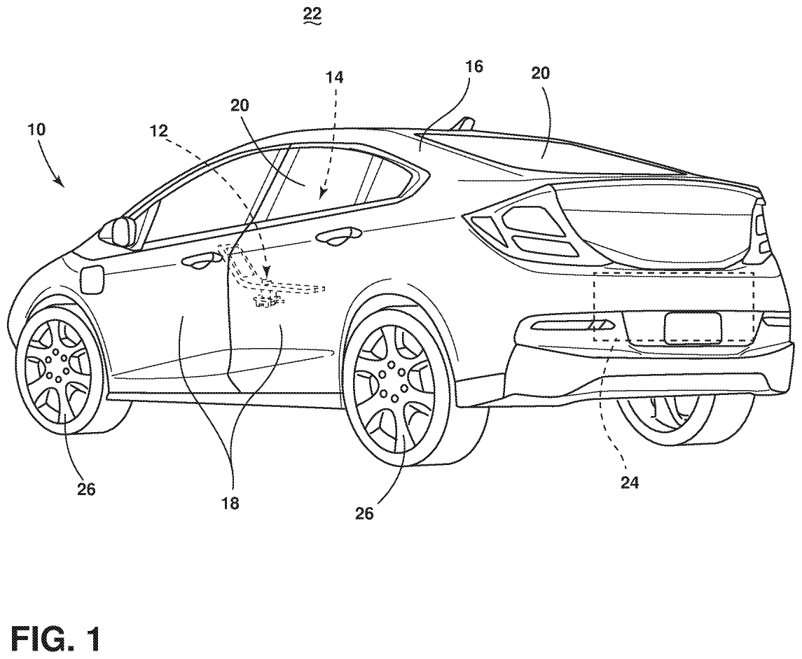

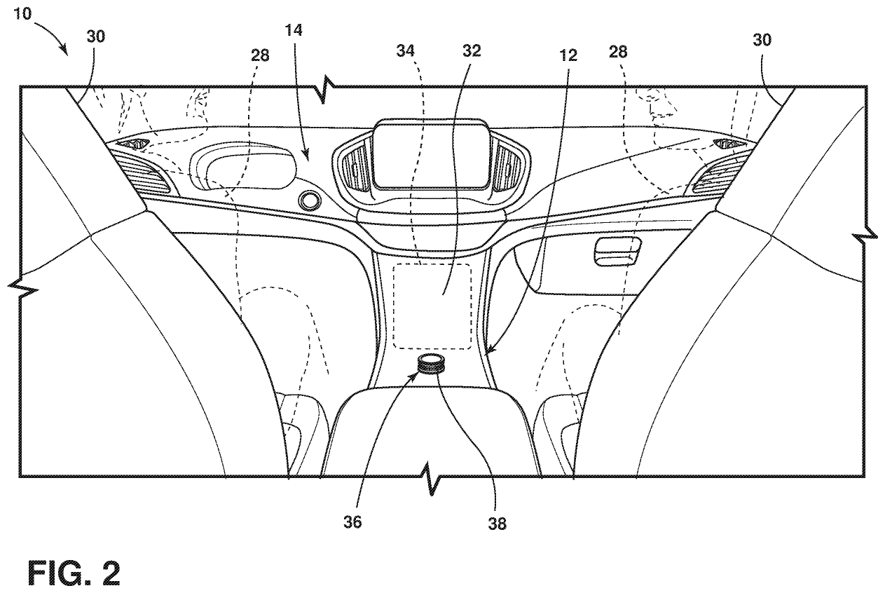

Referring now to FIGS. 1 and 2, a vehicle 10 includes a user interface 12. The vehicle 10 includes an interior 14, and the user interface 12 is disposed within the vehicle 10 accessible from the interior 14. The vehicle 10 includes panels 16, doors 18, and windows 20 that separate the interior 14 from an environment 22 external to the vehicle 10. The vehicle 10 includes a source of propulsion 24, such as an electric motor or a combustion engine (or both), that propels the vehicle 10. The vehicle 10 can include wheels 26. The source of propulsion 24 can cause the wheels 26 to rotate, thus propelling the vehicle 10. The vehicle 10 is configured to accept one or more passengers 28 into the interior 14 and transport the one or more passengers 28. In embodiments, the vehicle 10 includes seating assemblies 30 for the one or more passengers 28. In embodiments, as illustrated, the user interface 12 is disposed inboard of the seating assemblies 30 and generally laterally between the passengers 28 seated upon the seating assemblies 30. The vehicle 10 can be generally autonomously driven, and in embodiments, lacks a traditional steering wheel mounted forward of either of the seating assemblies 30. In embodiments, the vehicle 10 however includes a steering wheel. The vehicle 10 can be a car, a truck, a sports utility vehicle, a van, a passenger train car, an airplane, among other options.

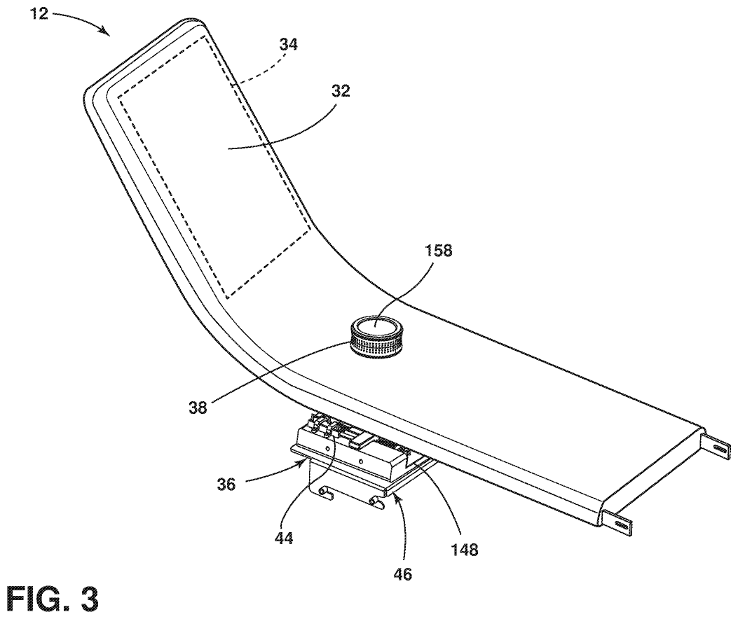

Referring now additionally to FIGS. 3-5, in embodiments, the user interface 12 includes a panel 32, a display 34, and a dial controller 36. In embodiments, the panel 32 isolates the display 34 from the interior 14. However, the panel 32 is sufficiently transparent in a region over the display 34 so that the display 34 is visible from the interior 14 through the panel 32. The panel 32 can be a plastic or glass material. In short, the display 34 is disposed below the panel 32 but visible through the panel 32. The display 34 can be a flat-panel display such as a liquid crystal display (LCD) or a light emitting diode (LED) display, among other options. As will be further discussed below, the user interface 12 can communicate with the passenger 28 visually via the display 34, and the passenger 28 can communicate with the user interface 12 via the display 34 and the dial controller 36. In embodiments, a panel separate from the panel 32 is disposed over the display 34.

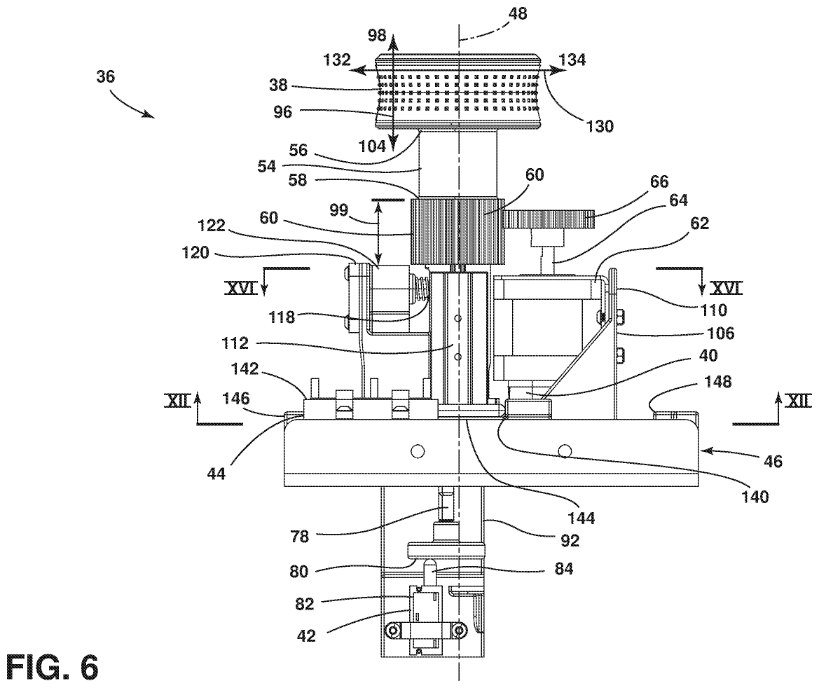

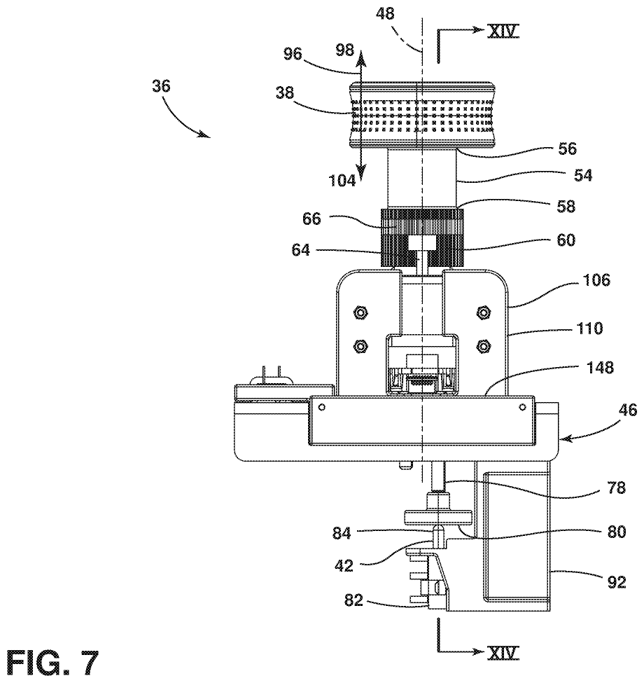

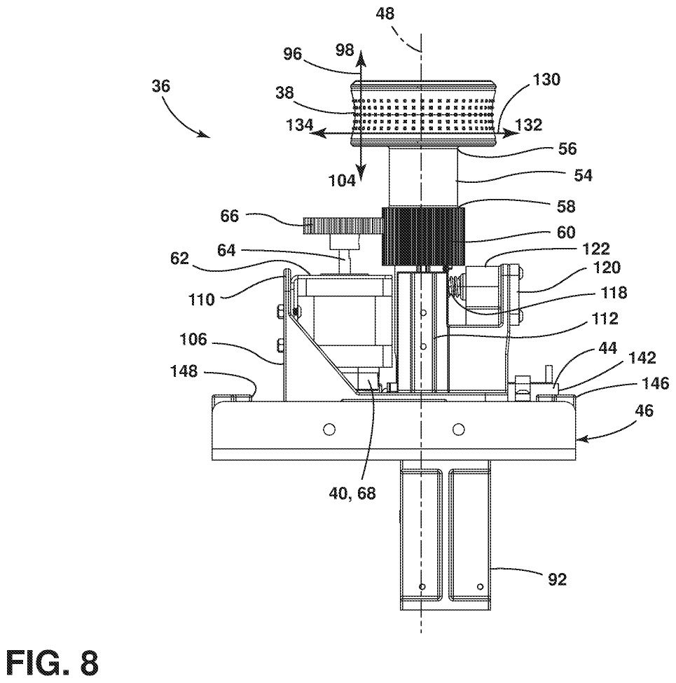

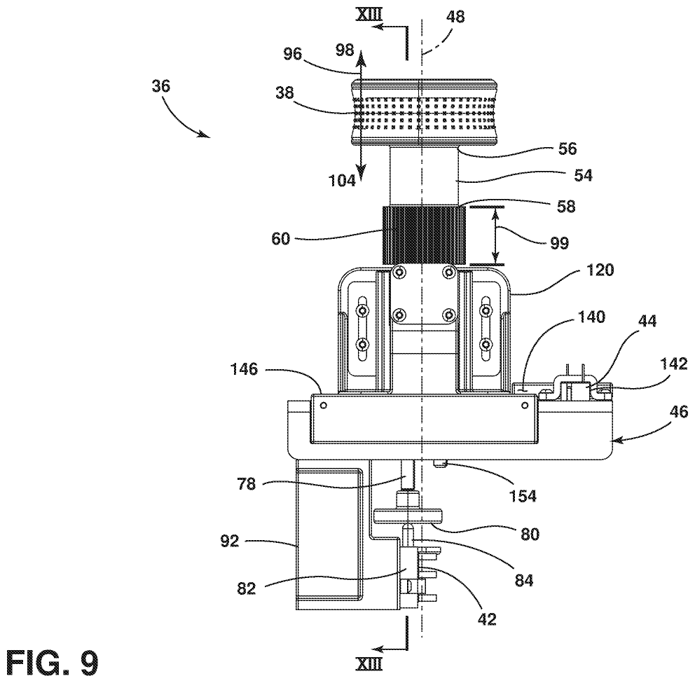

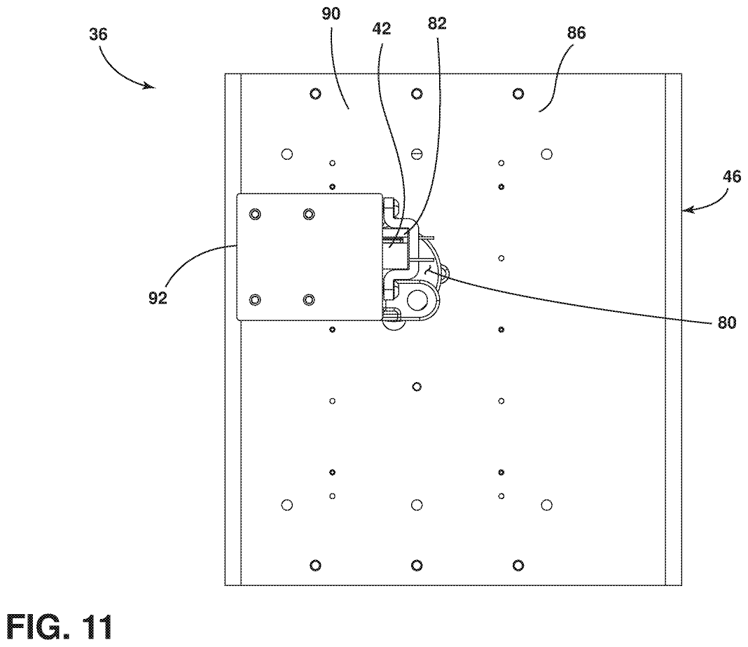

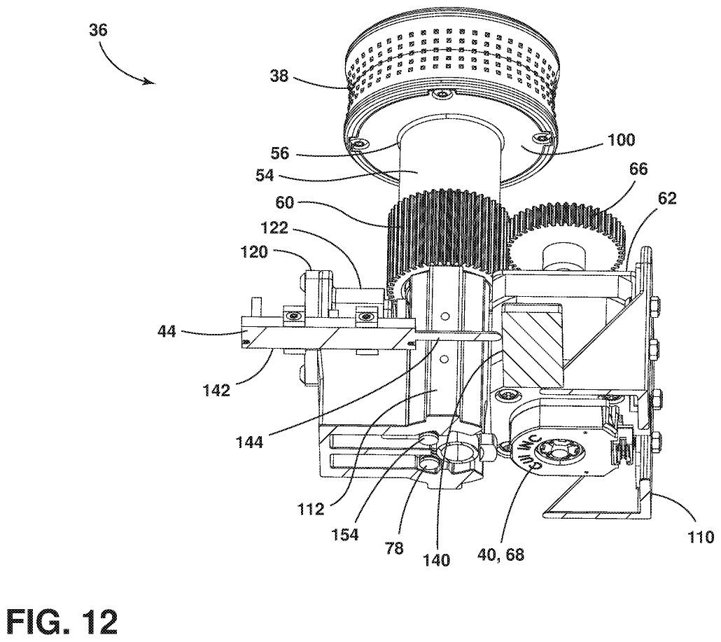

Referring now additionally to FIGS. 6-16, the dial controller 36 includes a rotatable dial 38, a first sensor 40, a second sensor 42, and a third sensor 44. All of the first sensor 40, the second sensor 42, and the third sensor 44 produce an output and are operably connected to the rotatable dial 38. In other words, movement of the rotatable dial 38 causes the output of one or more of the first sensor 40, the second sensor 42, and the third sensor 44 to change. The dial controller 36 further includes a fixed base 46 that is attached to the vehicle 10. The panel 32 of the user interface 12 separates the fixed base 46 from the interior 14. In short, the fixed base 46 of the dial controller 36 is disposed below the panel 32.

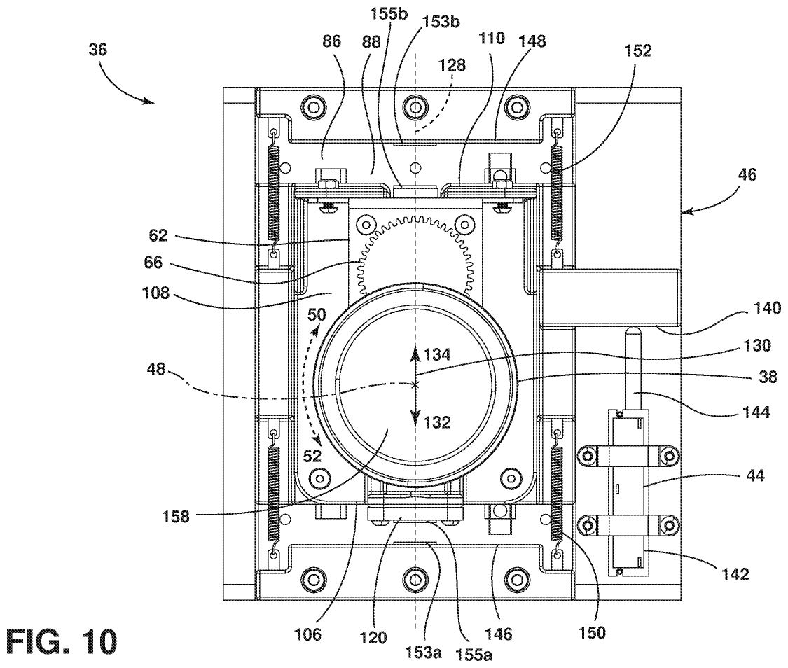

The rotatable dial 38 is rotatable about an axis of rotation 48. From an overhead perspective such as illustrated at FIG. 10, the rotatable dial 38 can rotate in both a clockwise direction 50 about the axis of rotation 48 and a counterclockwise direction 52 about the axis of rotation 48. To rotate the rotatable dial 38, the passenger 28 applies a torque to the rotatable dial 38 about the axis of rotation 48. The rotatable dial 38 is open to the interior 14, thus allowing for such interaction with the passenger 28.

As mentioned, the first sensor 40 is operably connected to the rotatable dial 38. In embodiments, dial controller 36 further includes a cylinder 54. The axis of rotation 48 extends through the cylinder 54. The cylinder 54 extends around the axis of rotation 48. The cylinder 54 has a first end 56 and a second end 58 along the axis of rotation 48. The rotatable dial 38 is attached to the first end 56 of the cylinder 54. The second end 58 of the cylinder 54 has a gear 60. Rotation of the rotatable dial 38 about the axis of rotation 48 thus causes the cylinder 54 to rotate, which causes the gear 60 at the second end 58 of the cylinder 54 to rotate.

In embodiments, the dial controller 36 further includes a stepper motor 62. The stepper motor 62 includes a shaft 64 and a gear 66 attached to the shaft 64. The gear 66 of the stepper motor 62 is operably connected to the gear 60 at the second end 58 of the cylinder 54 attached to the rotatable dial 38. Rotation of the gear 60 of the cylinder 54 (because of rotation of the rotatable dial 38) thus causes the gear 66 of the stepper motor 62 to rotate, which causes the shaft 64 of the stepper motor 62 to rotate. The shaft 64 of the stepper motor 62 is substantially parallel to the axis of rotation 48 of the rotatable dial 38.

In embodiments, the first sensor 40 is a rotary encoder 68. The rotary encoder 68 is positioned relative to the stepper motor 62 so that the rotary encoder 68 produces an output that is a function of a fraction of a rotation of the shaft 64 of the rotary encoder 68. Thus, as the rotatable dial 38 rotates, the shaft 64 of the stepper motor 62 rotates and the rotary encoder 68 produces an output from which each fraction of a rotation of the shaft 64 can be identified. The direction of rotation of the rotatable dial 38 can also be determined from the output of the rotary encoder 68. The output of the first sensor 40, in this instance the rotary encoder, thus is a function of rotation of the rotatable dial 38 about the axis of rotation 48, because rotation of the rotatable dial 38 causes rotation of the shaft 64.

In embodiments, the first sensor 40 is a Hall sensor. In such embodiments, a magnet can be attached to shaft 64 and the Hall sensor can be attached anywhere, such as at a bracket 110 to which the stepper motor 62 is attached, or at the stepper motor 62, where a fraction of a rotation of the shaft 64 and thus change in position of the magnet attached to the shaft 64 produce a change in magnetic field that the Hall sensor is able to sense and generate the associated output.

The stepper motor 62 resists rotation of the shaft 64 and thus rotation of the rotatable dial 38 at each fraction of a revolution of the shaft 64. A torque applied to the rotatable dial 38 (such as from the passenger 28) is required to overcome the resistance that the stepper motor 62 imparts and rotate the shaft 64 that fraction of the revolution. The resistance that the stepper motor 62 imparts after each fraction of the revolution of the shaft 64 prevents the rotatable dial 38 from freely rotating and offers a haptic feedback to the passenger 28 utilizing the dial controller 36, as will be further discussed below.

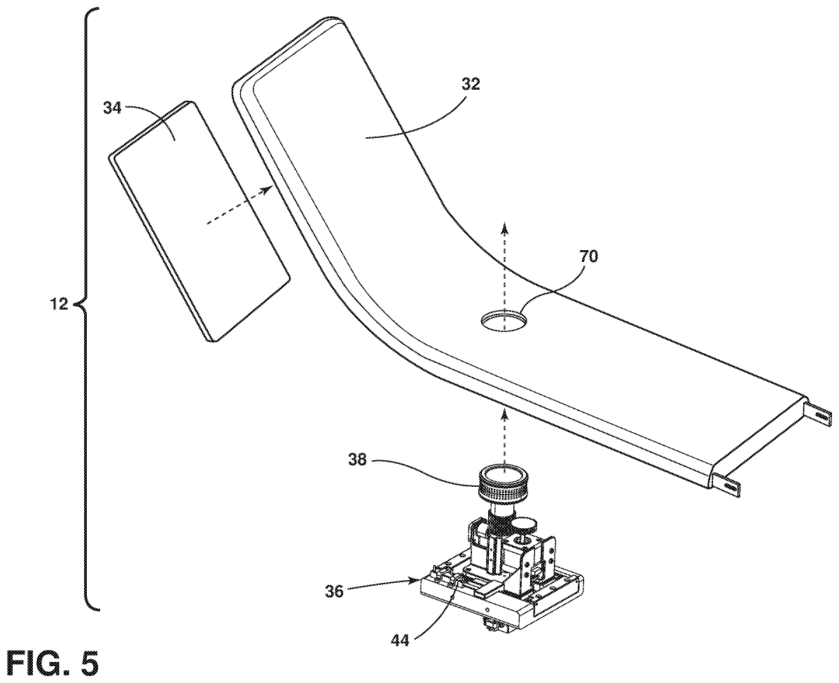

The rotatable dial 38 is disposed above the panel 32, exposing the rotatable dial 38 to the interior 14 of the vehicle 10. The passenger 28 is thus able to manipulate the rotatable dial 38. The panel 32 includes a slot 70 (see FIG. 5). The slot 70 is disposed below the rotatable dial 38. The cylinder 54 attached to the rotatable dial 38 extends through the slot 70 of the panel 32.

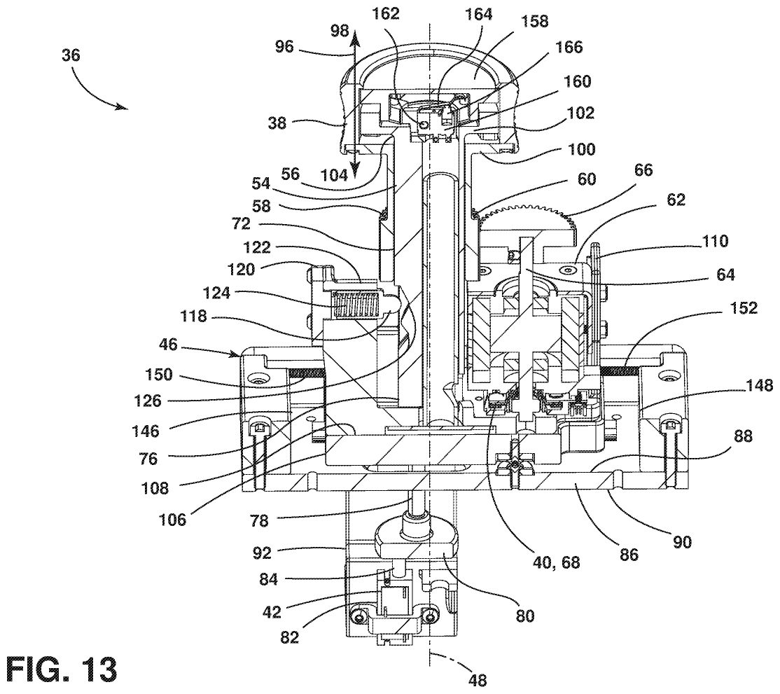

In embodiments, the dial controller 36 further includes a second cylinder 72 (see FIGS. 13, 14, and 16) through which the axis of rotation 48 of the rotatable dial 38 extends. The second cylinder 72 includes a first end 74 and a second end 76. The rotatable dial 38 rotates around the first end 74 of the second cylinder 72. In other words, the second cylinder 72 does not rotate (i.e., remains rotationally static) as the rotatable dial 38 rotates about the axis of rotation 48. The first end 74 of the second cylinder 72 is disposed above the panel 32, while the second end 76 of the second cylinder 72 is disposed below the panel 32.

The second cylinder 72 is operably connected to the second sensor 42. In embodiments, an extension 78 extends from the second end 76 of the second cylinder 72 substantially parallel to the axis of rotation 48 of the rotatable dial 38 and away from the first end 74 of the second cylinder 72. The extension 78 terminates in a sensor contacting surface 80. The sensor contacting surface 80 is substantially orthogonal to the axis of rotation 48 of the rotatable dial 38. The sensor contacting surface 80 contacts the second sensor 42.

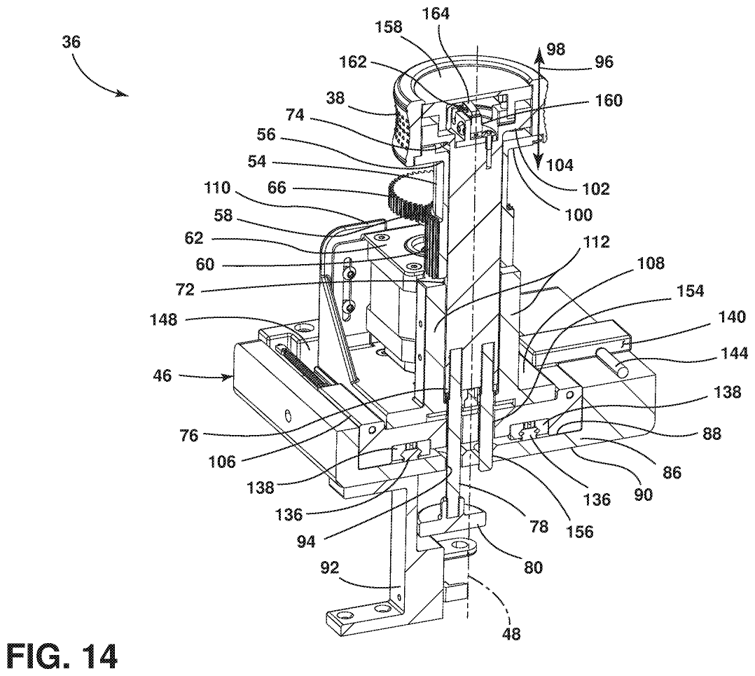

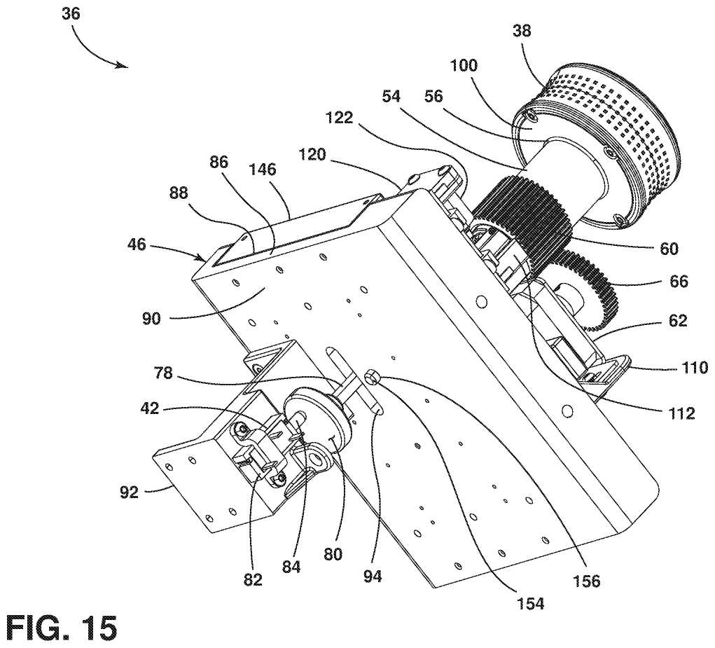

As mentioned, the second sensor 42 is operably connected to the rotatable dial 38. In embodiments, the second sensor 42 includes a fixed part 82 and a movable part 84. The movable part 84 is movable relative to the fixed part 82. The fixed part 82 of the second sensor 42 is statically attached to the fixed base 46 of the dial controller 36 that is attached to the vehicle 10. For example, as illustrated, the fixed base 46 can include a platform 86 that is substantially orthogonal to the axis of rotation 48, with the rotatable dial 38 disposed to one side 88 of the platform 86 and the second sensor 42 disposed to an opposite side 90 of the platform 86 as the rotatable dial 38. The fixed base 46 can include a bracket 92 extending from the platform 86 away from the opposite side 90, and the fixed part 82 of second sensor 42 is attached to the bracket 92. The movable part 84 of the second sensor 42 is biased, such as with a spring within the fixed part 82, to contact the sensor contacting surface 80 of the second cylinder 72. The platform 86 of the fixed base 46 includes a slot 94 (see FIGS. 14 and 15). The extension 78 from the second cylinder 72 extends through the slot 94 of the platform 86.

The rotatable dial 38 is movable along a line 96 parallel to the axis of rotation 48. In embodiments, the line 96 is coextensive with the axis of rotation 48. Movement of the rotatable dial 38 along the line 96 parallel to the axis of rotation 48 of the rotatable dial 38 causes the second cylinder 72 to move and thus the movable part 84 of the second sensor 42 to move. More specifically, a force imposed upon the rotatable dial 38 away from the fixed base 46 causes the rotatable dial 38 to move in a direction 98 (e.g., upwards). The rotatable dial 38 moving in the direction 98 causes the cylinder 54 to move in the direction 98 as well. The stepper motor 62 and thus the gear 66 attached to the stepper motor 62 do not move in the direction 98. However, the gear 60 of the cylinder 54 has a height 99 that is sufficient to maintain operable contact with the gear 66 of the stepper motor 62 while the cylinder 54 and thus the gear 60 move in the direction 98. Thus, rotation of the rotatable dial 38 still causes the gears 60, 66 to rotate allowing the first sensor 40 to produce output as a function of rotation of the rotatable dial 38. The cylinder 54 includes a flange 100 extending generally radially away from the axis of rotation 48, and the second cylinder 72 includes a flange 102 (see FIGS. 13 and 14) extending radially away from the axis of rotation 48. The flange 100 of the cylinder 54 is disposed between the fixed base 46 and the flange 102 of the second cylinder 72. The flange 100 of the cylinder 54 opposes the flange 102 of the second cylinder 72. Thus, movement of the cylinder 54 in the direction 98 causes the flange 100 of the cylinder 54 to contact the flange 102 of the second cylinder 72 and force the second cylinder 72 in the direction 98 as well. The extension 78 is attached to the second cylinder 72, as mentioned. Thus, as the second cylinder 72 moves in the direction 98, so does the extension 78, within the slot 94 through the platform 86 of the fixed base 46. Because the extension 78 terminates at the sensor contacting surface 80 and the movable part 84 of the second sensor 42 is biased to contact the sensor contacting surface 80, movement of the sensor contacting surface 80 in the direction 98 causes the movable part 84 of the second sensor 42 to move in the direction 98 as well. Ball bearings (not illustrated) can be disposed between the flange 102 of the second cylinder 72 and the flange 100 of the cylinder 54, to reduce friction as the cylinder 54 is rotated about axis of rotation 48 while the second cylinder 72 does not rotate.

The rotatable dial 38 can be forced in a direction 104 (e.g., downward) opposite of the direction 98, i.e., toward the fixed base 46, also along the line 96 parallel to axis of rotation 48 of the rotatable dial 38. Movement of the rotatable dial 38 in the direction 104 toward the fixed base 46 causes the cylinder 54 and the second cylinder 72 to move in that direction 104 as well. Movement of the second cylinder 72 in the direction 104 thus moves the extension 78, the sensor contacting surface 80, and the movable part 84 of the second sensor 42 in the direction 104 as well.

The second sensor 42 produces an output that changes as a function of movement of the rotatable dial 38 along the line 96 parallel to the axis of rotation 48 of the rotatable dial 38. In embodiments, the second sensor 42 is a linear displacement sensor. Movement of the movable part 84 of the second sensor 42 relative to the fixed part 82 of the second sensor 42 alters the output of the second sensor 42. Thus, positioning and movement of the rotatable dial 38 along the line 96 parallel to the axis of rotation 48 can be determined based on the output that the second sensor 42 produces.

In embodiments, the second sensor 42 is a Hall sensor, and the Hall sensor can be attached as the fixed part 82. Instead of the movable part 84 as described above, a magnet can be attached to the sensor contacting surface 80 of the second cylinder 72. Movement of the sensor contacting surface 80 thus moves the magnet attached thereto, thus altering the output of the Hall sensor. Thus, positioning and movement of the rotatable dial 38 along the line 96 parallel to the axis of rotation 48 can be determined based on the output that the second sensor 42, as a Hall sensor, produces.

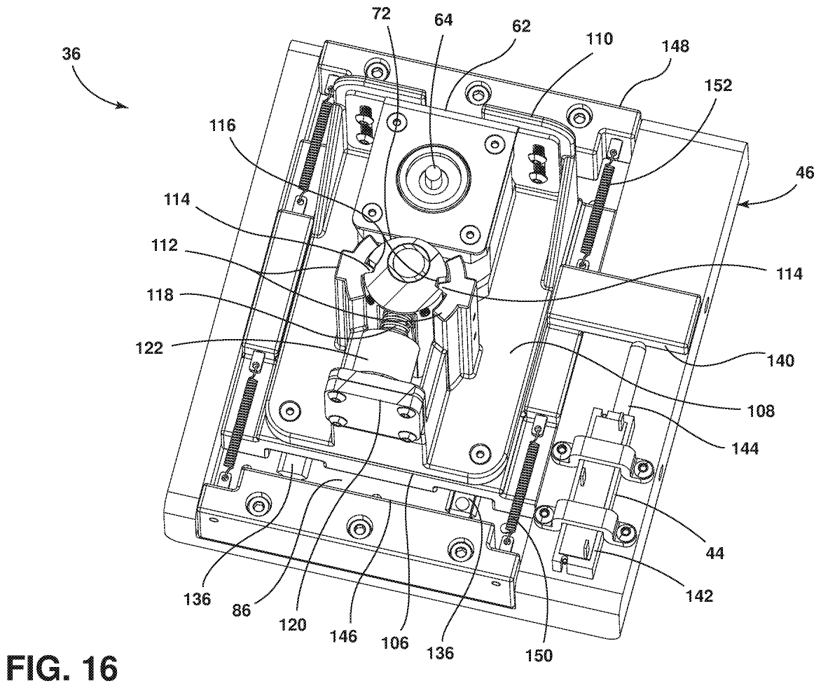

In embodiments, the dial controller 36 further includes a second base 106 coupled to the fixed base 46 and operably coupled to the rotatable dial 38. The second base 106, like the fixed base 46, is disposed below the panel 32. The second base 106 includes a platform 108 that is generally orthogonal to the axis of rotation 48 and parallel to the platform 86 of the fixed base 46. The second base 106 includes the bracket 110 to which the stepper motor 62 is attached, which prevents movement of the stepper motor 62 upon rotation of the rotatable dial 38 about the axis of rotation 48 of the rotatable dial 38, and maintains the gear 60 in operable contact with the gear 66. The second base 106 further includes a pair of braces 112 extending from the platform 108 generally parallel to the axis of rotation 48 toward the rotatable dial 38. One brace 112 opposes the other brace 112, with the second cylinder 72 disposed between the braces 112. The braces 112 extend radially around at least a portion of the second cylinder 72. The braces 112 maintain the second cylinder 72 aligned with the axis of rotation 48 of the rotatable dial 38. Each brace 112 includes a key 114 (see FIG. 16) that is generally parallel with the axis of rotation 48 and directed toward the second cylinder 72. The second cylinder 72 includes a pair of receivers 116 that receive the keys 114 of the braces 112. The keys 114 of the braces 112 cooperate with the receivers 116 of the second cylinder 72 to substantially prevent rotation of the second cylinder 72 about the axis of rotation 48 upon rotation of the rotatable dial 38 about the axis of rotation 48. However, because the keys 114 and the receivers 116 run parallel to the axis of rotation 48, the keys 114 permit movement of the second cylinder 72 in either directions 98, 104 (e.g., up or down) along the line 96 parallel to the axis of rotation 48.

The second base 106 further includes a retainer 118. The retainer 118 projects from the second base 106 toward the second cylinder 72. For example, in embodiments, the second base 106 includes a bracket 120 extending from the platform 108 in the direction 98. The bracket 120 holds a housing 122 for the retainer 118. The retainer 118 can retract into the housing 122 allowing the retainer 118 to be movable away from the second cylinder 72. However, a spring 124 (see FIG. 13) within the housing 122 biases the retainer 118 toward the second cylinder 72.

The second cylinder 72 further includes at least two indents 126. The at least two indents 126 are disposed between the first end 74 and the second end 76 of the second cylinder 72, with each indent 126 being spaced different between the first end 74 and the second end 76. In other words, the at least two indents 126 are sequentially disposed along the second cylinder 72 progressing from the first end 74 to the second end 76 of the second cylinder 72. The illustrated embodiment includes two indents 126, but the second cylinder 72 could include more than two indents 126, such as three, four, five, ten, fifty, and so on. The retainer 118 and the at least two indents 126 are positioned relative to each other so that the retainer 118 can project into one of the at least two indents 126 of the second cylinder 72 at a time. Which of the at least two indents 126 the retainer 118 projects into depends on the positioning of the rotatable dial 38, and thus the second cylinder 72, along the line 96 parallel with the axis of rotation 48. The retainer 118 being disposed within one of the at least two indents 126 maintains the positioning of the rotatable dial 38 along the line 96 parallel with the axis of rotation 48. Maintaining the positioning of the rotatable dial 38 prevents the second sensor 42 from producing an output indicative of a change in position.

The portion of the retainer 118 interacting with the at least one indents 126 is rounded and each of the at least two indents 126 is angled differently than orthogonal to the axis of rotation 48. Thus, a force can be applied to the rotatable dial 38 along the line 96 parallel to the axis of rotation 48 that overcomes the bias of the retainer 118 into one of the least two indents 126 of the second cylinder 72. The second cylinder 72 thus moves along the line 96 parallel to the axis of rotation 48 in either direction 98 (e.g., up) or direction 104 (e.g., down) (depending on the force), until the retainer 118 is aligned with another of the at least two indents 126 and the spring 124 biases the retainer 118 into that indent 126 of the at least two indents 126.

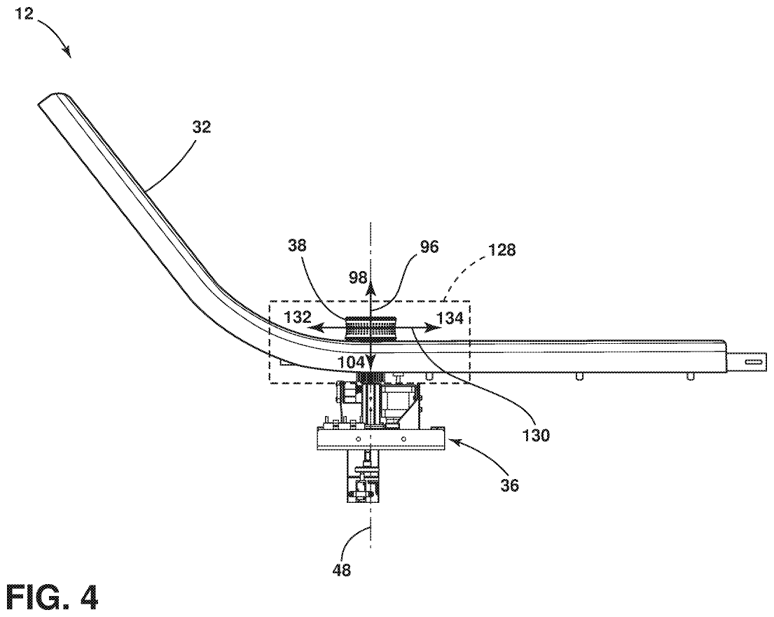

In addition to being rotatable about the axis of rotation 48 and linearly movable along the line 96 parallel to the axis of rotation 48, the rotatable dial 38 is movable along a plane 128 (see FIGS. 4 and 10) that is parallel to the axis of rotation 48. In embodiments, such as illustrated, the rotatable dial 38 is movable along a line 130, which exists on the plane 128, that is orthogonal to the axis of rotation 48. The rotatable dial 38 can move along the line 130 in either a direction 132 (e.g., forward) or a direction 134 (e.g., rearward), which is opposite of the direction 132. The direction 132 can be generally forward relative to the vehicle 10, and the direction 134 can be generally rearward relative to the vehicle 10. In other embodiments, the rotatable dial 38 is movable along an arc that exists on the plane 128.

The fixed base 46 further includes a pair of parallel rails 136 (see FIGS. 14 and 16) upon the platform 86, extending from the platform 86 toward the platform 108 of the second base 106. One of the rails 136 is disposed to one side of the plane 128. The other of the rails 136 is disposed to the other side of the plane 128. The second base 106 further includes a pair of guides 138, each guide 138 cooperating with one of the pair of rails 136 of the fixed base 46 to allow the second base 106 to move upon the pair of rails 136 along the plane 128 parallel to the axis of rotation 48 (and the line 130) while the fixed base 46 remains fixed in position. The pair of guides 138 and the pair of rails 136 further cooperate to substantially prevent movement of the second base 106 along the line 96 parallel to the axis of rotation 48. Thus, the second base 106 does not lift from the fixed base 46 when the rotatable dial 38 is moved in the direction 98 in the line 96 parallel to the axis of rotation 48. The pair of guides 138 and the pair of rails 136 additionally cooperate to substantially prevent the second base 106 from rotating relative to the fixed base 46 in response to rotation of the rotatable dial 38 about the axis of rotation 48.

As the rotatable dial 38 moves along the plane 128 parallel to the axis of rotation 48, the rotatable dial 38 forces the cylinder 54 and the second cylinder 72 to move along the plane 128 parallel to the axis of rotation 48 as well. The braces 112 extending up from the platform 108 of the second base 106 prevent the second cylinder 72 from tilting in the direction 132 and cause the second base 106 to move. In addition, the cylinder 54 and the second cylinder 72 move within the slot 70 through the panel 32. The slot 70 through the panel 32 is elongated sufficiently along the plane 128 parallel to the axis of rotation 48 to allow the cylinder 54 (and thus the second cylinder 72) to move in both the direction 132 and the direction 134 away from neutral. Similarly, the extension 78 from the second cylinder 72 moves within the slot 94 through the platform 86 of the fixed base 46, as the rotatable dial 38 moves along the plane 128 parallel to the axis of rotation 48.

As mentioned, the third sensor 44 of the dial controller 36 is operably connected to the rotatable dial 38. The third sensor 44 is attached to the fixed base 46. The second base 106 further includes a sensor contacting surface 140. The third sensor 44 includes a fixed part 142 and a movable part 144. The fixed part 142 is statically attached to the fixed base 46. The movable part 144 contacts the sensor contacting surface 140 of the second base 106. The movable part 144 of the third sensor 44 is movable relative to the fixed part 142, being able to extract out of and retract into the fixed part 142 of the third sensor 44 in response to movement of the second base 106 and thus the sensor contacting surface 140 of the second base 106. The movable part 144 of the third sensor 44 is biased toward the sensor contacting surface 140 of the second base 106. The movable part 144 of the third sensor 44 is parallel with the plane 128. Thus, as the second base 106 moves along the plane 128, the sensor contacting surface 140 of the second base 106 causes the movable part 144 of the third sensor 44 to move relative to the fixed part 142.

The third sensor 44 produces an output that is a function of positioning and movement of the rotatable dial 38 along the plane 128 parallel to the axis of rotation 48. For example, the third sensor 44 can be a linear displacement sensor, where the output produced is a function of the position of the movable part 144 relative to the fixed part 142. Thus, the position of the rotatable dial 38 along the plane 128 can be determined as a function of the output that the third sensor 44 produces.

In embodiments, the third sensor 44 is a Hall sensor. The Hall sensor can be attached to the fixed base 46 where the fixed part 142 is described above. A magnet can be attached to the sensor contacting surface 140. The output that the Hall sensor, as the third sensor 44, produces is thus a function of the position of the magnet on the sensor contacting surface 140 relative to the Hall sensor. Thus, the position of the rotatable dial 38 along the plane 128 can be determined as a function of the output that the third sensor 44 produces.

In embodiments, the rotatable dial 38 is biased to a neutral position that is not at an extreme in the direction 132 or an extreme in the direction 134. The fixed base 46 further includes a first wall 146 and a second wall 148 that opposes the first wall 146. Both the first wall 146 and the second wall 148 of the fixed base 46 extend from the platform 86 of the fixed base 46 in the same direction 98 that the pair of parallel rails 136 extend. The second base 106, as well as the pair of parallel rails 136, are disposed between the first wall 146 and the second wall 148 of the fixed base 46. A first spring 150 (see FIGS. 10, 13, and 16) is connected to both the first wall 146 of the fixed base 46 and the second base 106. A second spring 152 is connected to both the second wall 148 of the fixed base 46 and the second base 106. The first spring 150 and the second spring 152 thus pull the second base 106 in opposite directions 132, 134 and therefore bias the second base 106 (and the rotatable dial 38) to the neutral position along the plane 128 parallel to the axis of rotation 48. When a force is applied to the rotatable dial 38 that is sufficient to overcome the resistance imparted by either the first spring 150 or the second spring 152, the force thus moves the second base 106 and thus the rotatable dial 38 along the plane 128, simultaneously energizing one of the springs 150, 152. After the force ceases, whichever of the springs 150, 152 energized returns the second base 106 and thus the rotatable dial 38 to the neutral position.

In embodiments, in addition to, or in the alternative of, the first spring 150 and the second spring 152, the dial controller 36 further includes magnets 153a, 153b, 155a, and 155b. Magnets 153a and 153b are attached to the fixed base 46, specifically the first wall 146 and the second wall 148, respectively. Magnets 155a and 155b are attached to the second base 106 in positions that oppose the magnets 153a and 153b, respectively, such as on opposite sides of the platform 108. The magnets 153a and 155a produce magnetic fields that oppose each other. The magnets 153b and 155b produce magnetic fields that oppose each other. The magnets 153a, 153b, 155a, and 155b thus bias the second base 106 (and the rotatable dial 38) to the neutral position along the plane 128 parallel to the axis of rotation 48. When a force is applied to the rotatable dial 38 that is sufficient to overcome the resistance imparted by either the opposing magnetic fields of magnets 153a and 155a or 153b and 155b, the force thus moves the second base 106 and thus the rotatable dial 38 along the plane 128, simultaneously making the opposing magnetic forces of one of the pairs of magnets 153a/155a or 153b/155b oppose with greater vigor. After the force ceases, the opposing magnetic forces of the pairs of magnets 153a/155a or 153b/155b cause the second base 106 and thus the rotatable dial 38 to return to the neutral position where the opposing magnetic forces balance.

In embodiments, the rotatable dial 38 is not movable from the neutral position along the plane 128 unless the rotatable dial 38 is moved along the line 96 parallel to the axis of rotation 48 away from the second base 106 (e.g., upwards). For example, as illustrated, the second cylinder 72 can further include a second extension 154 that extends parallel to the extension 78. The platform 86 of the fixed base 46 further includes an aperture 156 into or through the platform 86 sized to receive the second extension 154. When the rotatable dial 38 is placed along the line 96 parallel to the axis of rotation 48 closest to the platform 86 of the fixed base 46 (e.g., downwards), the second extension 154 of the second cylinder 72 is disposed within the aperture 156 of the platform 86 of the fixed base 46. Thus, the rotatable dial 38 cannot move along the plane 128 parallel to the axis of rotation 48 in either the direction 132 (e.g., forward) or the direction 134 (e.g., rearward). The aperture 156 blocks movement of the second extension 154 and thus the rotatable dial 38. However, when the rotatable dial 38 is placed along the line 96 parallel to the axis of rotation 48 furthest from the platform 86 of the fixed base 46 (e.g., upwards), the second extension 154 of the second cylinder 72 is not disposed within the aperture 156 of the platform 86 of the fixed base 46. Thus, the rotatable dial 38 can move along the plane 128 parallel to the axis of rotation 48 if sufficient force is applied to overcome the resistance imparted by either the first spring 150 or the second spring 152 (and/or the resistance imparted by the opposing magnetic fields of the pairs of magnets 153a/155a or 153b/155b). The aperture 156 no longer blocks movement of the second extension 154. In embodiments, the dial controller 36 further includes a selector button 158 proximate the rotatable dial 38. The rotatable dial 38 can, as illustrated, encircle the selector button 158 radially about the axis of rotation 48 of the rotatable dial 38, with the selector button 158 intersecting the axis of rotation 48. As the rotatable dial 38 rotates about the axis of rotation 48, the selector button 158 does not rotate about the axis of rotation 48. In other embodiments, the selector button 158 can rotate as the rotatable dial 38 rotates.

In embodiments, the dial controller 36 further includes a fourth sensor 160 (see FIGS. 13 and 14). The fourth sensor 160 is operably connected to the selector button 158. The fourth sensor 160 includes a fixed part 162 and a movable part 164. The fixed part 162 of the fourth sensor 160 is attached to the first end 74 of the second cylinder 72 between the second cylinder 72 and the selector button 158. The selector button 158 is depressible along the axis of rotation 48 of the rotatable dial 38. The movable part 164 is a cantilevered spring that is biased to push the selector button 158 away from the second cylinder 72 along the axis of rotation 48, that is, away from being depressed (e.g., upwards).

The fourth sensor 160 produces an output that is a function of depression of the selector button 158. For example, the fourth sensor 160 can include a switch 166 between the movable part 164 of the fourth sensor 160 and the fixed part 162 of the fourth sensor 160. When the passenger 28 depresses the selector button 158, the selector button 158 pushes the movable part 164 and the movable part 164 activates the switch 166—producing an output indicative of the selector button 158 being depressed. In embodiments, the fourth sensor 160, along with the rotatable dial 38 and the selector button 158 are disposed above the panel 32 of the user interface 12.

In embodiments, all of the first sensor 40, the second sensor 42, and the third sensor 44 are disposed below the panel 32 and hidden from view from the interior 14. In contrast, the rotatable dial 38 and the selector button 158 are disposed above the panel 32. Thus, the passenger 28 can manipulate the rotatable dial 38 and the selector button 158 to control various functions of the vehicle 10. The fourth sensor 160 in embodiments is also disposed above the panel 32 but hidden from view from the interior 14 by the selector button 158 and the rotatable dial 38.

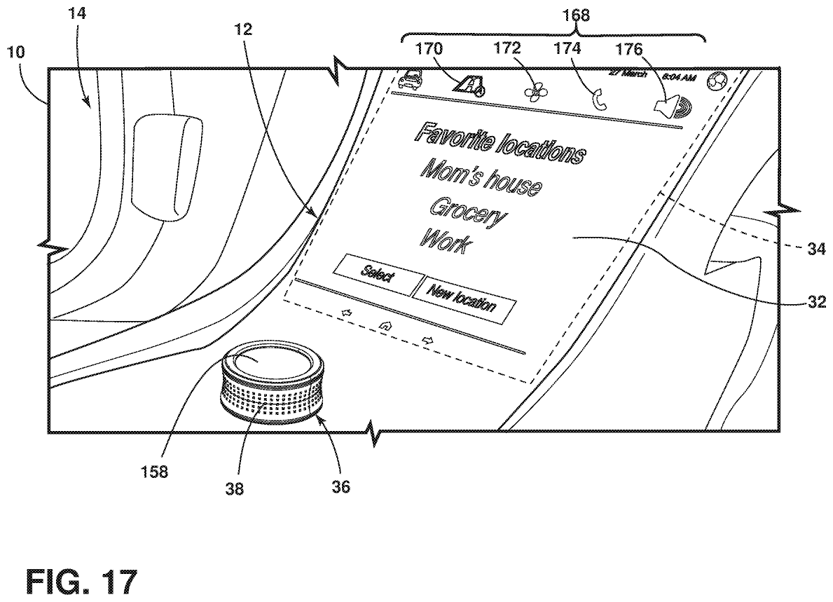

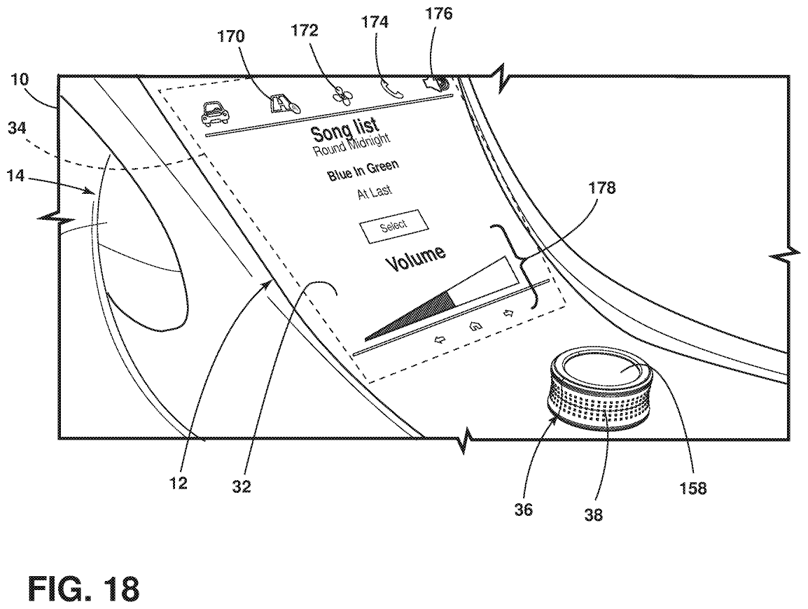

Referring now additionally to FIGS. 17-18, the dial controller 36 is in communication with the display 34. In embodiments, the display 34 displays a menu 168 of functions from which a function can be selected to use or control. For example, the menu 168 of functions can include the functions of navigation 170, interior climate control 172, communications 174, audio 176, and so on. The user interface 12 allows the passenger 28 to select, using the dial controller 36, which function from the menu 168 of functions to use or control. More specifically, the passenger 28 rotates the rotatable dial 38 about the axis of rotation 48 to scroll through the menu 168 of functions and choose which function from the menu 168 to use or control. In FIG. 17, the navigation 170 function is currently chosen for use or control. However, by rotating the rotatable dial 38 in the clockwise direction 50, the first sensor 40 produces an output indicative of the rotatable dial 38 being rotated in the clockwise direction 50 (as explained above), and the display 34 is caused to scroll among the functions of the menu 168 of functions, one function at a time. As described above, the stepper motor 62 resists rotation of the rotatable dial 38 and the passenger 28 must (in embodiments) overcome the resistance in order to rotate the rotatable dial 38 a fraction of a revolution and thus cause the display 34 to scroll to the next function in the menu 168 of functions. For example, the passenger 28 overcomes the resistance of the stepper motor 62 one time causing the rotatable dial 38 to rotate a fraction of a revolution and the display 34 displays the interior climate control 172 function to use or control. The passenger 28 overcomes the resistance a second time causing the rotatable dial 38 to rotate another fraction of a revolution and the display 34 displays the communications 174 category as the function to use or control. Finally, the passenger 28 overcomes the resistance a third time causing the rotatable dial 38 to rotate another fraction of a revolution and the display 34 displays the audio 176 function to use or control, as illustrated in FIG. 18. Depression of the selector button 158 by the passenger 28 confirms the choice and allows the passenger 28 use or control of the chosen function. As described above, the fourth sensor 160 produces an output indicative of depression of the selector button 158, and the user interface 12 allows the passenger 28 use or control of the chosen function from the menu 168. In embodiments, the user interface 12 causes the display 34 to display controllable aspects 178 of the chosen function. Rotation of the rotatable dial 38 about the axis of rotation 48 choses the particular aspect 178 to control, and depression of the selector button 158 confirms the choice. For example, as in FIG. 17, the passenger 28 can rotate the rotatable dial 38 among navigable locations and press the selector button 158 to confirm the choice-a navigation system then navigates the vehicle 10 to the selected navigable location. As another example, as in FIG. 18, the passenger 28 can rotate the rotatable dial 38 among aspects 178 related to audio 176 functions, such as a playlist or volume. The display 34 then displays the particular aspect 178 to control, for example volume of the audio 176 function. Rotation of the rotatable dial 38 controls the controllable aspect—in the case of FIG. 18, either increases or decreases the volume of the audio 176 within the vehicle 10. Again, the resistance that the stepper motor 62 applies to the rotatable dial 38 must be overcome to rotate the rotatable dial 38 the fraction of a revolution and cause a change in the controllable aspect 178—in the case of FIG. 18, incremental increase or decrease in the volume, or change of song among a list of songs in a playlist.

In embodiments, movement of the rotatable dial 38 along the line 96 parallel to the axis of rotation 48 (e.g., up or down) causes the display 34 to change from one menu 168 of functions to use or control to another menu 168 of functions to use or control. For example, when the rotatable dial 38 is placed in a position closer to the panel 32, the display 34 displays the menu 168 of functions already described. However, when the rotatable dial 38 is placed in a position further from the panel 32 (i.e., lifted upwards), the second sensor 42 produces output indicative of such placement and the user interface 12 causes the display 34 to display another menu 168 of functions, such as interior lighting control, vehicle diagnostics, seat position adjustment, and so on.

In embodiments, movement of the rotatable dial 38 along the line 96 parallel to the axis of rotation 48 causes the dial controller 36 to control movement of the vehicle 10. For example, when the rotatable dial 38 is placed in a position closer to the panel 32, the display 34 displays the menu 168 of functions already described. However, when the rotatable dial 38 is placed in a position further from the panel 32 (i.e., lifted upwards), the second sensor 42 produces output indicative of such placement and the vehicle 10 allows the passenger 28 to control movement of the vehicle 10 with the dial controller 36. In embodiments, movement of the rotatable dial 38 along the plane 128 parallel to the axis of rotation 48 causes the vehicle 10 to move forward or reverse. When the passenger 28 forces the rotatable dial 38 in the direction 132 (e.g., forward), the third sensor 44 produces an output indicative of such, and the user interface 12 causes the source of propulsion 24 to move the vehicle 10 in that direction 132. When the passenger 28 forces the rotatable dial 38 in the direction 134 (e.g., rearward), the third sensor 44 produces an output indicative of such, and the user interface 12 causes the source of propulsion 24 to move the vehicle 10 in that direction 134. As the vehicle 10 is moving, when the passenger 28 causes rotation of the rotatable dial 38 about the axis of rotation 48, the first sensor 40 produces an output indicative of such, and causes the vehicle 10 to turn. Assuming that the vehicle 10 is moving in the direction 132 (e.g., forward), the passenger 28 rotating the rotatable dial 38 in the clockwise direction 50 would result in the vehicle 10 turning right. Assuming that the vehicle 10 is moving in the direction 132 (e.g., forward), the passenger 28 rotating the rotatable dial 38 in the counterclockwise direction 52 would result in the vehicle 10 turning left. The ability of the dial controller 36 to control movement of the vehicle 10 is especially beneficial when the vehicle 10 lacks a traditional steering wheel.

With the user interface 12 implementing the dial controller 36, the passenger 28 has easy access to virtually all controllable aspects of the vehicle 10. From climate and audio 176 control to causing the vehicle 10 to move, the passenger 28 can control it all with the dial controller 36. The passenger 28 need not navigate by pressing and swiping a touch screen user interface. The locations of particular functions to control are easily learned and controllable through either rotation of the rotatable dial 38, lifting or lowering the rotatable dial 38, or pushing forward/pulling back the rotatable dial 38.

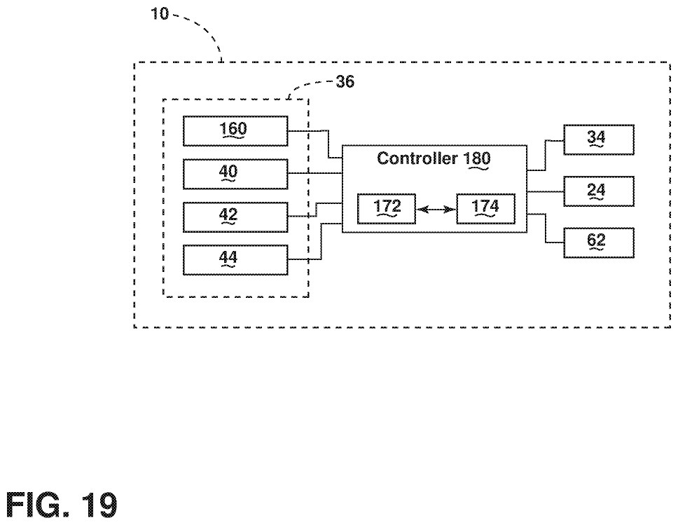

Referring now to FIG. 19, the vehicle 10 further includes a controller 180. The controller 180 includes a processor 172 and memory 174. The memory 174 stores programs that the processor 172 executes to perform the functions commanded at the user interface 12. The controller 180 is in communication with, and accepts as input, the output of the first sensor 40, the second sensor 42, the third sensor 44, and the fourth sensor 160 of the dial controller 36. The controller 180 is in further communication with, and controls, the source of propulsion 24 and the display 34. In embodiments, the controller is in further communication with, and controls, the stepper motor 62. The menu 168 of functions can be stored in the memory 174. The controller 180 can cause the display 34 to display the menu 168 of functions. The controller 180 causes the display 34 to display different menus 168, to scroll among the functions of the menu 168, and display the controllable aspects 178 of the chosen function in accordance with output received from the first sensor 40, the second sensor 42, the third sensor 44, and the fourth sensor 160 of the dial controller 36, as explained above. In embodiments, the controller 180 also controls the selected controllable aspect 178 according to output received from the first sensor 40, the second sensor 42, the third sensor 44, and the fourth sensor 160 of the dial controller 36, such as causes speakers within the vehicle 10 to change volume, causes interior lights to change output, change seat positions, etc. As mentioned, the controller 180 is in communication with the source of propulsion 24 of the vehicle 10, and can cause the source of propulsion 24 to propel the vehicle 10 in accordance with user commands at the dial controller 36 in response to output received from the first sensor 40, the second sensor 42, the third sensor 44, and the fourth sensor 160 of the dial controller 36.

1. A dial controller for a vehicle comprising:
a rotatable dial that is (i) rotatable about an axis of rotation, (ii) linearly movable along a line parallel to the axis of rotation, and (iii) movable along a plane parallel to the axis of rotation;
a first sensor operably connected to the rotatable dial, the first sensor producing an output that is a function of rotation of the rotatable dial about the axis of rotation;
a second sensor operably connected to the rotatable dial, the second sensor producing an output that is a function of movement of the rotatable dial along the line parallel to the axis of rotation; and
a third sensor operably connected to rotatable dial, the third sensor producing an output that is a function of movement of the rotatable dial along the plane parallel to the axis of rotation.

2. The dial controller of claim 1 further comprising:
a selector button proximate the rotatable dial, the selector button being depressible along the axis of rotation of the rotatable dial; and
a fourth sensor operably connected to the selector button, the fourth sensor producing an output that is a function of depression of the selector button.

3. The dial controller of claim 2, wherein:
the rotatable dial encircles the selector button about the axis of rotation of the rotatable dial;
the selector button intersects the axis of rotation of the rotatable dial;
as the rotatable dial rotates about the axis of rotation, the selector button does not rotate about the axis of rotation; and
the selector button is biased along the axis of rotation away from being depressed.

4. (canceled)

5. (canceled)

6. The dial controller of claim 1 further comprising:
a stepper motor comprising a shaft and a gear attached to the shaft;
wherein, the rotatable dial is attached to a first end of a cylinder through which the axis of rotation extends;
wherein, the cylinder further comprises a second end and a gear at the second end that is operably connected to the gear of the stepper motor;
wherein, rotation of the rotatable dial about the axis of rotation causes the cylinder to rotate and thus the gear at the second end of the cylinder to rotate;
wherein, rotation of the gear of the cylinder causes the gear of the stepper motor to rotate, and rotation of the gear of the stepper motor causes the shaft of the stepper motor to rotate;
wherein, the first sensor is positioned relative to the stepper motor to generate an output that is a function of a fraction of a revolution of the shaft;
wherein, the stepper motor resists rotation of the shaft and thus rotation of the rotatable dial at each fraction of the revolution of the shaft; and
wherein, a torque applied to the rotatable dial is required to overcome the resistance.

7. (canceled)

8. (canceled)

9. The dial controller of claim 6, wherein:
the shaft of the stepper motor is substantially parallel to the axis of rotation of the rotatable dial.

10. The dial controller of claim 1 further comprising:
a second cylinder through which the axis of rotation of the rotatable dial extends, the second cylinder comprising a first end around which the rotatable dial rotates and a second end from which an extension extends, the extension terminating in a sensor contacting surface that contacts the second sensor;
wherein, the second sensor is a linear displacement sensor comprising (i) a fixed part statically attached to a fixed base of the dial controller and (ii) a movable part that contacts the sensor contacting surface of the second cylinder, the movable part being movable relative to the fixed part, and movement of the movable part of the second sensor relative to the fixed part of the second sensor alters the output of the second sensor;
wherein, the movable part is biased toward the sensor contacting surface of the second cylinder; and
wherein, movement of the rotatable dial along the line parallel to the axis of rotation of the rotatable dial causes the second cylinder to move and thus the movable part of the second sensor.

11. The dial controller of claim 10 further comprising:
a second base coupled to the fixed base, the fixed base substantially denying movement of the second base along the line parallel to the axis of rotation; and
a retainer projecting from the second base toward the second cylinder, the retainer being movable away from the second cylinder but biased toward the second cylinder;
wherein, the second cylinder further comprises at least two indents disposed between the first end and the second end of the second cylinder, the at least two indents being spaced differently between the first end and the second end;
wherein, the retainer is configured to project into one of the at least two indents of the second cylinder at a time; and
wherein, a force applied to the rotatable dial along the line parallel to the axis of rotation overcomes bias of the retainer into one of the at least two indents of the second cylinder, the second cylinder moves along the line parallel to the axis of rotation, and the retainer is biased to project into another of the at least two indents of the second cylinder.

12. (canceled)

13. The dial controller of claim 1 further comprising:
a fixed base to which the third sensor is attached; and
a second base to which the rotatable dial is attached, the second base (i) comprising a sensor contacting surface and (ii) movable along the plane parallel to the axis of rotation;
wherein, the third sensor is a linear displacement sensor comprising (i) a fixed part statically attached to the fixed base and (ii) a movable part that contacts the sensor contacting surface of the second base, the movable part being movable relative to the fixed part, and the output that the third sensor produces is a function of position of the movable part relative to the fixed part;
wherein, the movable part of the third sensor is biased toward the sensor contacting surface of the second base; and
wherein, movement of the second base along the plane parallel to the axis of rotation of the rotatable dial causes the movable part of the third sensor to move.

14. The dial controller of claim 13, wherein:
the fixed base comprises a platform and a pair of parallel rails upon the platform;
one rail of the pair of parallel rails is disposed to one side of the plane and the other rail is disposed to the other side of the plane; and
the second base moves relative to the fixed base upon the pair of parallel rails.

15. The dial controller of claim 13, wherein:
the fixed base further comprises a first wall and a second wall extending from the platform, with the second base and the pair of parallel rails disposed between the first wall and the second wall;
the dial controller further comprises a first spring connected to both the first wall of the fixed base and the second base;
the dial controller further comprises a second spring connected to both the second wall of the fixed base and the second base;
the first spring and the second spring cooperate to bias the second base and thus the rotatable dial to a neutral position along the plane parallel to the axis of rotation; and
the rotatable dial is moved along the plane when resistance imparted by either the first spring or the second spring is overcome.

16. (canceled)

17. (canceled)

18. The dial controller of claim 13 further comprising:
a second cylinder through which the axis of rotation of the rotatable dial extends, the second cylinder comprising a first end around which the rotatable dial rotates and a second end from which an extension extends, the extension terminating in a sensor contacting surface that contacts the second sensor;
wherein, the second sensor is disposed on a different side of the platform as the rotatable dial;
wherein, the platform of the fixed base comprises a slot; and
wherein, the extension from the second cylinder extends through the slot of the platform.

19. The dial controller of claim 18, wherein:
the second cylinder further comprises a second extension;
the platform of the fixed base further comprises an aperture sized to receive the second extension;
when the rotatable dial is placed along the line parallel to the axis of rotation closest to the platform of the fixed base, the second extension of the second cylinder is disposed within the aperture of the platform of the fixed base and the rotatable dial cannot move along the plane parallel to the axis of rotation; and
when the rotatable dial is placed along the line parallel to the axis of rotation furthest from the platform of the fixed base, the second extension of the second cylinder is not disposed within the aperture of the platform of the fixed base and the rotatable dial can move along the plane parallel to the axis of rotation.

20. A user interface for a vehicle comprising:
a panel;
a display;
a dial controller in communication with the display, the dial controller comprising:
a rotatable dial disposed above the panel, the rotatable dial being (i) rotatable about an axis of rotation, (ii) linearly movable along a line parallel to the axis of rotation, and (iii) movable along a plane parallel to the axis of rotation;
a first sensor operably connected to the rotatable dial and disposed below the panel, the first sensor producing an output that is a function of rotation of the rotatable dial about the axis of rotation;
a second sensor operably connected to the rotatable dial and disposed below the panel, the second sensor producing an output that is a function of movement of the rotatable dial along the line parallel to the axis of rotation; and
a third sensor operably connected to rotatable dial and disposed below the panel, the third sensor producing an output that is a function of movement of the rotatable dial along the plane parallel to the axis of rotation.

21. The user interface of claim 20, wherein:
the dial controller further comprises:
a selector button proximate the rotatable dial, the selector button being depressible above the panel along the axis of rotation of the rotatable dial; and
a fourth sensor disposed above the panel and operably connected to the selector button, the fourth sensor producing an output that is a function of depression of the selector button.

22. The user interface of claim 21, wherein:
the display displays a menu of functions to use or control;
rotation of the rotatable dial about the axis of rotation chooses a function from a menu of functions to use or control;
depression of the selector button confirms the choice and allows use or control of the chosen function; and
rotation of the rotatable dial about the axis of rotation controls a controllable aspect of the chosen function.

23. (canceled)

24. The user interface of claim 20, wherein:
the panel comprises a slot disposed below the rotatable dial;
the dial controller further comprises a second cylinder through which the axis of rotation of the rotatable dial extends;
the second cylinder comprises a first end disposed above the panel around which the rotatable dial rotates and a second end disposed below the panel from which an extension extends, the extension terminating in a sensor contacting surface that contacts the second sensor;
the second sensor is a linear displacement sensor comprising (i) a fixed part statically attached to a fixed base of the dial controller and (ii) a movable part that contacts the sensor contacting surface of the second cylinder, the movable part being movable relative to the fixed part, and movement of the movable part of the second sensor relative to the fixed part of the second sensor alters the output of the second sensor;
the movable part is biased toward the sensor contacting surface of the second cylinder;
movement of the rotatable dial along the line parallel to the axis of rotation of the rotatable dial causes the second cylinder to move and thus the movable part of the second sensor; and
movement of the rotatable dial along the plane parallel to the axis of rotation causes the second cylinder of the dial controller to move within the slot through the panel.

25. (canceled)

26. The user interface of claim 20, wherein:
movement of the rotatable dial along the line parallel to the axis of rotation of the rotatable dial causes the display to change from displaying one menu of functions to use or control to displaying another menu of functions to use or control.

27. The user interface of claim 20, wherein:
the user interface is disposed within a vehicle;
movement of the rotatable dial along the line parallel to the axis of rotation of the rotatable dial causes the dial controller to control movement of the vehicle;
movement of the rotatable dial along the plane parallel to the axis of rotation causes the vehicle to move forward or reverse; and
rotation of the rotatable dial about the axis of rotation causes the vehicle to turn.

28. The user interface of claim 20, wherein:
a fixed base disposed below the panel to which the third sensor is attached;
a second base disposed below the panel to which the rotatable dial is operably coupled, the second base (i) comprising a sensor contacting surface and (ii) movable along the plane parallel to the axis of rotation;
the third sensor is a linear displacement sensor comprising (i) a fixed part statically attached to the fixed base and (ii) a movable part that contacts the sensor contacting surface of the second base, the movable part being movable relative to the fixed part, and the output the third sensor produces is a function of position of the movable part relative to the fixed part;
the movable part of the third sensor is biased toward the sensor contacting surface of the second base; and
movement of the second base along the plane parallel to the axis of rotation of the rotatable dial causes the movable part of the third sensor to move.

29. (canceled)

30. (canceled)

31. The user interface of claim 21, wherein:
the rotatable dial, the selector button, and the fourth sensor are all disposed above the panel; and
the display is disposed below but visible through the panel.

32. (canceled)
